(19) United States
(12) Patent Application Publication
(10) Pub. No.: US 2023/0186596 A1
(43) Pub. Date: Jun. 15, 2023

(54) OBJECT RECOGNITION METHOD, APPARATUS, DEVICE AND STORAGE MEDIUM

(71) Applicant: SENSETIME INTERNATIONAL PTE. LTD., Singapore (SG)

(72) Inventors: Wenbin ZHANG, Singapore (SG); Yao ZHANG, Singapore (SG); Shuai ZHANG, Singapore (SG); Shuai YI, Singapore (SG)

(21) Appl. No.: 17/562,183

(22) Filed: Dec. 27, 2021

Related U.S. Application Data
(63) Continuation of application No. PCT/IB2021/061915, filed on Dec. 17, 2021.

(30) Foreign Application Priority Data
Dec. 10, 2021 (SG) 10202113727X

(51) Int. Cl. G06V 10/75

(52) U.S. Cl. CPC G06V 10/757; G06V 10/751

(57) ABSTRACT

An object recognition method, apparatus, device and storage medium are provided. The method includes the following steps: a real-time image where a screen includes an object operation region is acquired; image reference points that match with at least two reference origins in the real-time image is determined according to the mapping relationship between the real-time image and a preset standard image, the reference origin is a point within the object operation region in the preset standard image; and an object within the object operation region is recognized according to a pixel coordinate of the preset standard image and a reference pixel coordinate of the image reference point in the real-time image to obtain a target recognition result of the object.

### CROSS-REFERENCE TO RELATED APPLICATIONS

This is a continuation application of International Patent Application No. PCT/IB 2021/061915, filed on 17 Dec. 2021, which claims priority to Singapore Patent Application No. 10202113727X, filed to the Singapore Patent Office on 10 Dec. 2021 and entitled “OBJECT RECOGNITION METHOD, APPARATUS, DEVICE AND STORAGE MEDIUM”. The disclosures of International Patent Application No. PCT/IB2021/061915 and Singapore Patent Application No. 10202113727X are incorporated herein by reference in their entireties.

### BACKGROUND

In the related art, a plurality of images are obtained by collecting objects according to different angles, and object recognition is performed on a plurality of images at the same time to obtain the final recognition result of a object. However, the object recognition results in the images collected from different angles may be different, which will affect the accuracy of the final recognition results.

### SUMMARY

The embodiments of the present disclosure relate to the field of image processing, and in particular, to an object recognition method, apparatus, device, and storage medium.

The embodiments of the present disclosure provide a technical solution for object recognition.

The technical solution in the embodiments of the present disclosure is implemented as follows.

The embodiments of the present disclosure provide an object recognition method, the method includes the following step.

A real-time image where a screen includes an object operation region is acquired.

Image reference points that match with at least two reference origins in the real-time image is determined according to the mapping relationship between the real-time image and a preset standard image. The reference origin is a point within the object operation region in the preset standard image.

An object within the object operation region is recognized according to a pixel coordinate of the preset standard image and a reference pixel coordinate of the image reference point in the real-time image to obtain a target recognition result of the object.

The embodiments of the present disclosure provide an object recognition apparatus. The apparatus may include an acquisition module, a determination module, and a recognition module.

The acquisition module is configured to acquire a real-time image where a screen includes an object operation region.

The determination module is configured to determine, according to the mapping relationship between the real-time image and a preset standard image, image reference points that match with at least two reference origins in the real-time image, the reference origin is a point within the object operation region in the preset standard image.

The recognition module is configured to recognize an object within the object operation region according to a pixel coordinate of the preset standard image and a reference pixel coordinate of the image reference point in the real-time image to obtain a target recognition result of the object.

Correspondingly, the embodiments of the present disclosure provide a computer device. The computer device includes a memory storing computer-executable instructions thereon and a processor, when the processor runs the computer-executable instructions stored on the memory, the above object recognition method can be implemented.

The embodiments of the present disclosure provide a computer storage medium. The computer-executable instructions are stored on the computer storage medium, and after the computer-executable instructions are executed, the above object recognition method can be implemented.

Embodiments of the disclosure provide a computer program product, comprising computer readable codes, wherein when the computer readable codes run in a device, a processor in the device executes instructions for implementing the steps in the foregoing method.

### BRIEF DESCRIPTION OF THE DRAWINGS

In order to more clearly describe the technical solutions in the embodiments of the present disclosure, the following will briefly introduce the drawings needed in the description of the embodiments. It is apparent that the drawings in the following description are only some embodiments in the embodiments of the present disclosure. For a person of ordinary skill in the art, other drawings may be obtained according to these drawings without creative effect:

FIG. 1 illustrates a schematic flowchart of an object recognition method according to embodiments of the present disclosure.

FIG. 2 illustrates a schematic flowchart of a second object recognition method according to embodiments of the present disclosure.

FIG. 3 illustrates a schematic flowchart of a third object recognition method according to embodiments of the present disclosure.

FIG. 4 illustrates a schematic diagram of a game tabletop according to embodiments of the present disclosure.

FIG. 5 illustrates a composition schematic diagram of an object recognition device according to embodiments of the present disclosure.

FIG. 6 illustrates a composition schematic diagram of a computer device according to embodiments of the present disclosure.

### DETAILED DESCRIPTION

The embodiments of the present disclosure provide an object recognition method, apparatus, device and storage medium. Firstly, a real-time image where a screen includes an object operation region is acquired; secondly, image reference points that match with at least two reference origins in the real-time image is determined according to the mapping relationship between the real-time image and a preset standard image, the reference origin is a point within the object operation region in the preset standard image; and finally, an object within the object operation region is recognized according to a pixel coordinate of the preset standard image and a reference pixel coordinate of the image reference point in the real-time image to obtain a target recognition result of the object. In such a way, the target recognition result of the object may be obtained according to the pixel coordinate of the preset standard image, the reference pixel coordinate of the image reference point corresponding to the reference origin of the preset standard image in the real-time image, and the recognition result of the object in the real-time image, which may improve the accuracy of object recognition.

In order to make the objectives, technical solutions, and advantages in the embodiments of the present disclosure clearer, the specific technical solutions of the invention will be described in further detail below in combination with the drawings in the embodiments of the present disclosure. The following embodiments are used to illustrate the embodiments of the present disclosure, but are not used to limit the scope of the embodiments of the present disclosure.

In the following description, “some embodiments” are referred to, which describe a subset of all possible embodiments, but it may be understood that “some embodiments” may be the same subset or different subsets of all possible embodiments, and may be combined with each other without conflict.

In the following description, the term “first\second\third” involved only distinguishes similar objects, and does not represent a specific order for the objects. It may be understood that the specific order or sequence of “first\second\third” may be interchanged if permitted, so that the embodiments of the present disclosure described herein may be implemented in a sequence other than those illustrated or described herein.

Unless otherwise defined, all technical and scientific terms used herein have the same meaning as commonly understood by a person skilled in the technical field belonging to the embodiments of the present disclosure. The term used herein is only for the object of describing the embodiments of the present disclosure, and is not intended to limit the embodiments of the present disclosure.

Before describing the embodiments of the present disclosure in further detail, the terms and terms involved in the embodiments of the present disclosure will be described. The terms and terms involved in the embodiments of the present disclosure are applicable to the following explanations.

1) The top view is a view obtained by orthographic projection from above the object.

2) Transformation matrix is a concept in mathematical linear algebra. In linear algebra, linear transformation may be represented by matrices. If T is a linear transformation that maps Rn to Rm, and x is a column vector with n elements, the m×n matrix A is called as the transformation matrix of T.

Exemplary applications of the object recognition device according to the embodiments of the present disclosure will be described in the following. The device according to the embodiments of the present disclosure may be implemented as various types of user terminals, such as a notebook computer, tablet computer, desktop computer, camera, mobile device (for example, personal digital assistant, dedicated messaging device, and portable game device), and may also be implemented as servers. In the following, exemplary applications when the device is implemented as a terminal or a server will be described.

The method may be applicable by a computer device, and the functions implemented by the method may be implemented by a processor in the computer device calling program codes. Certainly, the program codes may be stored in a computer storage medium, and it may be seen that the computer device at least includes a processor and a storage medium.

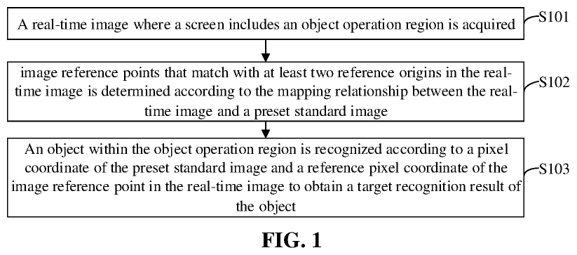

The embodiments of the present disclosure provide an object recognition method. As illustrated in FIG. 1 which illustrates a schematic flowchart of an object recognition method according to embodiments of the present disclosure; the following description will be made with reference to the steps as illustrated in FIG. 1.

In S101, a real-time image where a screen includes an object operation region is acquired.

In some embodiments, the real-time image may be acquired by the object recognition apparatus through the internal image collection module, or sent by an apparatus or device that may interact with it. Accordingly, the real-time image may be a color image or a grayscale image. The object operation region may be located in the foreground region, the middle background region, and the background region of the real-time image.

In some embodiments, the real-time image may be image data collected on a game tabletop, and the real-time image may also be image data collected on a chess board. The area, size, and shape of the object operation region may be determined according to actual needs. Correspondingly, when the object operation region is a game tabletop, screen of the real-time image may also include game props placed on the game tabletop, such as game currencies or playing cards; when the object operation region is a chess board, the screen of the real-time image may also include the chess pieces placed on the chess board.

In S102, image reference points that match with at least two reference origins in the real-time image is determined according to the mapping relationship between the real-time image and a preset standard image.

The reference origin is a point within the object operation region in the preset standard image.

In some embodiments, the preset standard image may refer to an image collection image set above the center of the object operation region to collect the object operation region to obtain a top view standard image.

In some embodiments, the preset standard image may be a reference image set in advance and associated with the object operation region, which is a standard image for subsequent comparison with the real-time image.

In some embodiments, the number of reference origins in the object operation region in the preset standard image may be two or more; at least two reference origins may be a plurality of points on a straight line within the object operation region in the preset standard image. Exemplarily, the reference origin may be two points on the center line within the object operation region in the preset standard image, that is, the image reference points that match at least two reference origins are two points of the center line within the object operation region in the real-time image.

In some embodiments, at least two reference origins may be sequentially mapped to the real-time image according to the mapping relationship between the real-time image and the preset standard image to obtain corresponding image reference points.

In some embodiments, the mapping relationship may be represented by a mapping transformation matrix that maps a preset standard image to a real-time image. Exemplarily, the mapping relationship represents a transformation matrix for converting between the pixel coordinates of at least four actual reference points in the preset standard image and the pixel coordinates of the corresponding reference points in the real-time image.

In S103, an object within the object operation region is recognized according to a pixel coordinate of the preset standard image and a reference pixel coordinate of the image reference point in the real-time image to obtain a target recognition result of the object.

In some embodiments, the object within the object operation region in the real-time image is recognized according to the pixel coordinate of the preset standard image and the reference pixel coordinate of the image reference point in the real-time image to obtain the target recognition result of the object. The corresponding to-be-referenced side view image may be determined according to the pixel coordinate of the preset standard image and the reference pixel coordinate of the image reference point in the real-time image. The side view image is an image that corresponds to the real-time image and is obtained by performing image collection on the object operation region in a different orientation. Furthermore, object recognition is performed on the side view image and the real-time image respectively to obtain two recognition results, so as to determine the target recognition result of the object based on the two recognition results.

In some embodiments, the positional relationship between any object placed in the object operation region in the real-time image and the image reference point is determined through the image reference point of the real-time image corresponding to the reference origin of the preset standard image and the pixel coordinate of the preset standard image. The side view corresponding to the object operation region to be referred to is determined according to the positional relationship. The recognition result corresponding to the side view is merged into the recognition result of the object in the real-time image to obtain the target recognition result of the object within the object operation region. In such a way, the accuracy of object recognition may be improved.

In the object recognition method according to the embodiments of the present disclosure, firstly, a real-time image where a screen includes an object operation region is acquired; secondly, image reference points that match with at least two reference origins in the real-time image is determined according to the mapping relationship between the real-time image and a preset standard image, the reference origin is a point within the object operation region in the preset standard image; and finally, an object within the object operation region is recognized according to a pixel coordinate of the preset standard image and a reference pixel coordinate of the image reference point in the real-time image to obtain a target recognition result of the object. In such a way, the target recognition result of the object may be obtained according to the pixel coordinate of the preset standard image, the reference pixel coordinate of the image reference point corresponding to the reference origin of the preset standard image in the real-time image, and the recognition result of the object in the real-time image, which may improve the accuracy of object recognition.

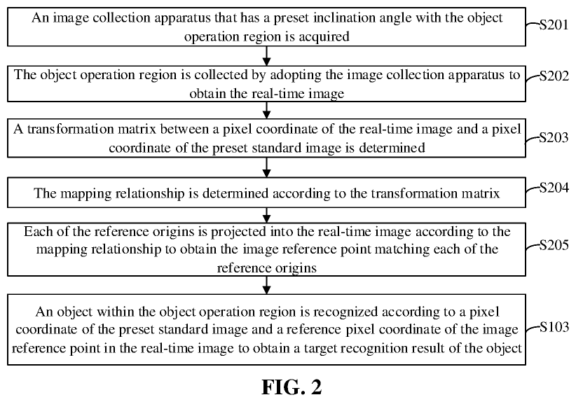

In some embodiments, by the transformation matrix between the pixel coordinate of the real-time image and the pixel coordinate of the preset standard image, the mapping relationship between the real-time image and the preset standard image is determined. In such a way, the accuracy of determining the mapping relationship between the preset standard image and the real-time image may be improved. As illustrated in FIG. 2, FIG. 2 illustrates a flow realization diagram of a second object recognition method according to an embodiment of the present disclosure; the following description will be made with reference to the steps illustrated in FIG. 1 and FIG. 2:

In S201, an image collection apparatus that has a preset inclination angle with the object operation region is acquired.

In some embodiments, the image collection apparatus may be installed on the top of the object operation region, and the top view is obtained by collecting the object operation region. The preset inclination angle may be 90 degrees or less than 90 degrees. Exemplarily, the preset inclination angle is 0 to 90 degrees. At the same time, the preset inclination angle may also be determined according to the actual image collection requirements of the application scene where the object operation region.

In some embodiments, when the object operation region is the game tabletop, the image collection apparatus may be an image collection apparatus with a preset inclination angle to the game tabletop. When the object operation region is the chess board, the image collection apparatus may be an image collection apparatus with a preset inclination angle to the chess board.

In S202, the object operation region is collected by adopting the image collection apparatus to obtain the real-time image.

In some embodiments, the object operation region is collected by adopting the image collection apparatus to obtain the real-time image. The number of real-time images may be one or two or more. When the number of frames of the real-time images is two or more, the image collection angle of each frame of the real-time images is the same, and at the same time, the postures of the image collection apparatus corresponding to any two real-time images may be the same or different.

In some embodiments, the object operation region may be collected for real-time image collection by adopting the image collection apparatus within a preset time period to obtain at least two consecutive frames of real-time images. In this way, an accuracy of the obtained top view real-time image where the screen includes the target operation region may be improved.

In some possible implementations, obtaining the preset standard image may be achieved by the following processes.

In the first step, a first collection angle of the real-time image is determined.

In some embodiments, the object recognition apparatus determines the first collection angle of the real-time image. The first collection angle may refer to the angle when the image collection apparatus collects the object operation region, that is, the angle between the image collection apparatus and the plane where the object operation region is placed. The first collection angle may be changed according to actual needs.

In the second step, the object operation region is collected by adopting a second collection angle to obtain the preset standard image.

The difference between the second collection angle and the first collection angle is less than a preset angle threshold.

In some embodiments, the object operation region is collected by the second collection angle whose difference with the first collection angle is less than the preset angle threshold to obtain the preset standard image. The preset standard image may be obtained by collecting the object operation region by an image collection apparatus set perpendicular to the center of the object operation region. The preset standard image may also be obtained by an image collection apparatus that collects the real-time image to acquire the preset standard image.

In some embodiments, the preset standard image may be a reference image set in advance and associated with the target object, which is a standard image for subsequent comparison with the real-time image. In this way, the top view standard image corresponding to the real-time image, that is, the preset standard image may be efficiently acquired.

Here, before determining the image reference points that match at least two reference origins in the real-time image according to the mapping relationship between the real-time image and the preset standard image, that is, before performing S102 in the above embodiments, the following S203 and S204 may also be executed.

In S203, a transformation matrix between a pixel coordinate of the real-time image and a pixel coordinate of the preset standard image is determined.

In some embodiments, a transformation matrix is determined according to the conversion relationship between the pixel coordinate of the point associated with the object operation region in the preset standard image and the pixel coordinate of the point associated with the object operation region in the real-time image. The transformation matrix may be adopt to project the preset standard image to obtain the real-time image; or, the transformation matrix may be adopted to inverse project the real-time image to obtain the preset standard image; and at the same time, the parameters in the transformation matrix are used to perform linear transformation and translation two images.

In a possible implementation, the corresponding transformation matrix is determined by preset reference points in the preset standard image and respective pixel coordinates of the image mapping points matching the preset reference points in the real-time image. In such a way, the accuracy of the determined transformation matrix may be higher. That is, the above S203 may be implemented by the following S231 to S233 (not illustrated in the figure):

In S231, a preset reference point and a first pixel coordinate of the preset reference point are determined in the preset standard image.

In some embodiments, the preset reference point may refer to at least four points associated with the object operation region in the preset standard image, which exemplarily may be four corners of the object operation region. The first pixel coordinate of the preset reference point is pixel coordinates of the preset reference points in the preset standard image, and may be represented by (x1,y1).

In some embodiments, the preset reference point may be preset in advance. The preset reference point may be a plurality of boundary points of the object operation region in the preset standard image.

In S232, a second pixel coordinate of an image mapping point that matches the preset reference point is determined in the real-time image.

In some embodiments, in the real-time image, the image mapping point matching the preset reference point may be set in advance. In the case where the preset reference points are a plurality of boundary points of the object operation region in the preset standard image, correspondingly, the image mapping points are a plurality of boundary points of the object operation region in the real-time image. That is, the preset reference point and the image mapping point are respectively corresponding points in the preset standard image and the real-time image of the plurality of boundary points of the object operation region. At the same time, the second pixel coordinate of the image mapping point is the pixel coordinate of the image mapping point in the real-time image, which may be represented by (x2,y2).

In S233, the transformation matrix between the first pixel coordinate and the second pixel coordinate is determined.

In some embodiments, a perspective transformation matrix between the first pixel coordinate and the second pixel coordinate is determined, that is, the transformation matrix; the essence of the perspective transformation is to project the image to a new viewing plane, which may be a transformation that may convert an oblique line that may appear in the figure into a straight line through a perspective transformation. Exemplarily, the boundary lines of the object operation region in the preset standard image are all straight lines, while oblique lines may exist in the boundary lines of the object operation region in the real-time image.

In S204, the mapping relationship is determined according to the transformation matrix.

In some embodiments, the mapping relationship may be directly represented according to the transformation matrix. In such a way, the mapping relationship between the preset standard image and the real-time image may be determined.

Here, S103 in the above embodiment, that is, determining the image reference points matching at least two reference origins in the real-time image according to the mapping relationship between the real-time image and the preset standard image, may be implemented by the following S205.

In S205, each of the reference origins is projected into the real-time image according to the mapping relationship to obtain the image reference point matching each of the reference origins.

In some embodiments, each of the reference origins is projected into the real-time image by adopting a mapping relationship, that is, a transformation matrix between a real-time image and a preset standard image, to obtain an image reference point.

In some embodiments, the pixel coordinate of each of the reference origins in the preset standard image may be projected into the real-time image according to the mapping relationship. Correspondingly, a plurality of pixel coordinates are determined in the real-time image; and furthermore, the plurality of pixel coordinates in the real-time image are sequentially determined as image reference points. In such a way, the corresponding image reference point in the real-time image may be determined by the reference origin in the preset standard image and the mapping relationship, which may reduce the amount of calculation and improve the accuracy of determining the image reference point in the real-time image.

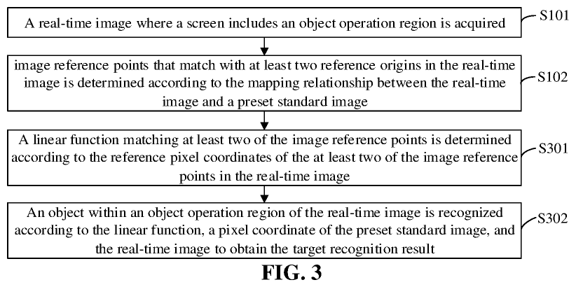

In some embodiments, in the real-time image, a linear function matching the image reference point is determined, and then the object in the object operation region of the real-time image is recognized according to the linear function and the pixel coordinate of the preset standard image to obtain the target object recognition result. In such a way, the accuracy of object recognition may be improved. As illustrated in FIG. 3, FIG. 3 illustrates a flow realization diagram of a third object recognition method according to embodiments of the present disclosure; the following description will be made with reference to the steps shown in FIG. 1 and FIG. 3.

In S301, a linear function matching at least two of the image reference points is determined according to the reference pixel coordinates of the at least two of the image reference points in the real-time image.

In some embodiments, the abscissas and ordinates of the at least two image reference points in the reference pixel coordinate of the real-time image may be numerically calculated to determine a linear function matching the at least two image reference points.

In some embodiments, the reference pixel coordinate of the image reference point A in the real-time image is (x1, y1), and the reference pixel coordinate of the image reference point B in the real-time image is (x2, y2), and the linear function corresponding to the straight line formed by the image reference points A and the image reference point B may be calculated, that is, the straight line expression: y=Ax+B.

In S302, an object within an object operation region of the real-time image is recognized according to the linear function, a pixel coordinate of the preset standard image, and the real-time image to obtain the target recognition result.

In some embodiments, the corresponding numerical result may be determined according to the linear function and the pixel coordinate of the preset standard image, and then the target recognition result of the object may be obtained according to the numerical result and the real-time image.

In some possible implementations, the pixel coordinate of the preset standard image may be input to the linear function to obtain the relevant coordinate result, and then the target recognition result of the object may be determined according to the coordinate result and the real-time image. In such a way, the accuracy of the object recognition may be improved. That is, the above S302 may be implemented by the following S321 to S324 (not illustrated in the figure):

In S321, a pixel coordinate of the preset standard image is input into the linear function to obtain a to-be-compared coordinate.

In some embodiments, the abscissa in the pixel coordinate of the preset standard image is input to the linear function to obtain the first ordinate, that is, the to-be-compared coordinate. The first ordinate and the ordinate in the pixel coordinate of the preset standard image may be the same or different.

In some embodiments, the ordinate in the pixel coordinate of the preset standard image is input to the linear function to obtain the first abscissa, that is, the to-be-compared coordinate. The first abscissa and the abscissa in the pixel coordinate of the preset standard image may be the same or different.

In S322, the pixel coordinate of the preset standard image is numerically compared with the to-be-compared coordinate to obtain a comparison result.

Here, according to the above embodiments, when the abscissa in the pixel coordinate of the preset standard image is input to the linear function, the ordinate in the pixel coordinate of the preset standard image may be numerically compared with the to-be-compared coordinate to obtain the comparison result. When the ordinate in the pixel coordinate of the preset standard image is input to the linear function, the abscissa in the pixel coordinate of the preset standard image is numerically compared with the to-be-compared coordinate to obtain the comparison result. In the following embodiments, the ordinate in the pixel coordinate of the preset standard image input to the linear function is taken as an example for description.

In S323, an object within the object operation region in the real-time image is recognized to obtain a to-be-adjusted recognition result.

In some embodiments, a commonly used object recognition model may be adopted to recognize the object of the object operation region in the real-time image to obtain the to-be-adjusted recognition result. When the object operation region is the game tabletop, object recognition may be performed on the game currencies or playing cards placed on the game tabletop collected in the real-time image. When the object operation region is the chess board, object recognition may be performed on the chess pieces placed on the chess board collected in the real-time image.

In S324, a target recognition result of the object is determined according to the comparison result and to-be-adjusted recognition result.

In some embodiments, according to the comparison result, a target side view image may be filtered from the side view images associated with the real-time image, and then the target recognition result of the object may be determined according to the to-be-adjusted recognition results corresponding to the target side view image and the real-time image.

In a possible implementation, in the case where the preset standard image is a top view standard image, the corresponding side view image may be obtained according to the comparison result, and then the target recognition result of the object is determined according to the to-be-adjusted recognition results corresponding to the side view and the real-time image. In such a way, the accuracy of object recognition may be improved. That is, the above S324 may be implemented in two situations.

In the first situation, that is, in the case where the preset standard image is a top view standard image, when the comparison result represents that the pixel coordinate of the preset standard image is less than or equal to the to-be-compared coordinate, the above S324 may be implemented by the following S3241 to S3243 (not illustrated in the figure):

In S3241, in the case where the comparison result represents that the pixel coordinate of the preset standard image is less than or equal to the to-be-compared coordinate, a right side view image where a screen includes the object operation region is acquired.

In some embodiments, the collection angle of the right side view image is perpendicular to the first collection angle of the real-time image. In the case where the comparison result represents that the pixel coordinate of the preset standard image is less than or equal to the to-be-compared coordinate, that is, the point corresponding to the pixel coordinate of the preset standard image is on the right side of the straight line constituted by at least two image reference points, and furthermore, the right side view image where the screen includes the object operation region, i.e., the side view image obtained by image collection of the object operation region on the right side of the object operation region, is obtained.

In some embodiments, the collection angle of the right side view image is perpendicular to the first collection angle of the real-time image, and the image collection apparatus of the real-time image may be set on the top of the object operation region, and at the same time, the image collection apparatus of collecting the right side view image may set on the first side surface of the object operation region.

In S3242, the object within the object operation region in the right side view image is recognized to obtain a first recognition result.

In some embodiments, the object recognition model may be adopted to recognize the object within the object operation region in the right side view image to obtain the first recognition result; the first recognition result may be the same as or different from the to-be-adjusted recognition result. And at the same time, the recognition algorithm of performing object recognition on real-time image may be the same as or different from the recognition algorithm of performing object recognition on the right side view image.

In S3243, the to-be-adjusted recognition result is adjusted according to the first recognition result to obtain the target recognition result.

In some embodiments, the to-be-adjusted recognition result may be adjusted or modified by adopting the first recognition result to obtain the target recognition result of the object, or the first recognition result and the to-be-adjusted recognition result may be merged to obtain the target recognition result of the object.

In the second situation, that is, in the case where the preset standard image is a top view standard image, when the comparison result represents that the pixel coordinate of the preset standard image is greater than or equal to the to-be-compared coordinate, the above S324 may be implemented by the following S3244 to S3246 (not illustrated in the figure).

In S3244, in the case where the comparison result represents that the pixel coordinate of the preset standard image is greater than or equal to the to-be-compared coordinate, a left side view image where a screen includes the object operation region is acquired.

The collection angle of the left side view image is perpendicular to the first collection angle of the real-time image.

In some embodiments, in the case where the comparison result represents that the pixel coordinate of the preset standard image is greater than or equal to the to-be-compared coordinate, that is, the point corresponding to the pixel coordinate that represents the preset standard image is on the left side of the straight line constituted by at least two image reference points, a left side view image where the screen includes the object operation region, that is, a side view image obtained by image collection of the object operation region on the left side of the object operation region, is obtained.

In some embodiments, the collection angle of the left side view image is perpendicular to the first collection angle of the real-time image, and the image collection apparatus of the real-time image may be set at the top of the object operation region and the image collection apparatus of collecting the left side view image may be set on the second side surface of the object operation region.

The first side surface is different from the second side surface.

In S3245, the object within the object operation region in the left side view image is recognized to obtain a second recognition result.

In some embodiments, the object recognition model may be adopted to recognize the object in the object operation region in the left side view image to obtain the second recognition result; the second recognition result may be the same as or different from the to-be adjusted recognition result. At the same time, the recognition algorithm of performing object recognition on the real-time image may be the same as or different from the recognition algorithm of performing the object recognition on the left side view image.

In S3246, the to-be-adjusted recognition result is adjusted according to the second recognition result to obtain the target recognition result.

In some embodiments, the to-be-adjusted recognition result is adjusted or modified by adopting the second recognition result to obtain the target recognition result of the object, or the second recognition result and the to-be-adjusted recognition result may be merged to obtain the target recognition result of the object.

In some embodiments, the side view image matching the real-time image is determined by determining the pixel coordinate and the linear function of the preset standard image, and then the target recognition result is determined according to the respective object recognition results of the side view image and the real-time image. In such a way, when there is an angular deviation in the real-time image collection of the object operation region, the probability of an object recognition error due to the incorrect selection on the side view image may be reduced, and the accuracy of the object recognition may be further improved.

The above object recognition method will be described below in combination with a specific embodiment. However, it is worth noting that this specific embodiment is only for better describing the embodiments of the present disclosure, and does not constitute an improper limitation on the embodiments of the present disclosure.

In the game location, each of the game tabletops is usually captured by three cameras in real-time to obtain the left side image, right side image, and top view image of the game tabletop. At the same time, the intelligent analysis system detects and recognizes human hands, poker cards, game currencies and other objects that appear on the game tabletop from the three views of real-time images (left side view image, right side view image, and top view image). The game currencies are taken as an example, due to the overlap and occlusion of the game currencies, the recognition of the game currencies may only be carried out in the left and right side view images, and the output of the game currencies of the entire system only needs the top view image information, which requires the system to be able to accurately recognize the information of the game currencies from the side view images and merge the information into the top view image. When the game currencies may be recognized in both side view images, there will be a result selection problem. According to the selection on the side view image of the object's abscissa, the center line of the game tablecloth may not be vertical due to the installation position of the camera in the top view image, or the center line may not be strictly at the half of the image width. In some situations, an error in the final recognition result may occur. By the object recognition method proposed in the above embodiments, the probability of an error in the object recognition result due to incorrect selection of the side view image may be reduced, and the accuracy of the object recognition may be improved, which is implemented by the following steps:

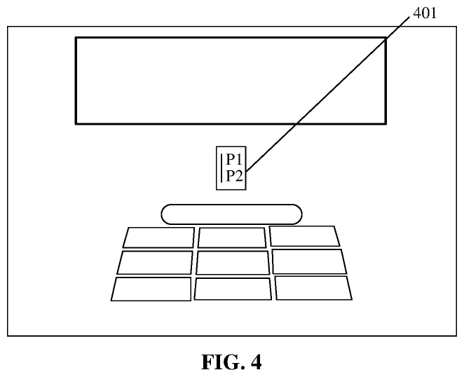

In the first step, when camera calibration is performed on the image collection apparatus corresponding to the game tabletop, two points on the center line of the game tabletop are selected to form a line segment, as illustrated in P1 and P2 in FIG. 4. FIG. 4 is a schematic diagram of applying a game tabletop according to embodiments of the present disclosure, and at the same time, 401 is a straight line composed of P1 and P2, that is, a center line.

In the second step, the mapping T from the top view standard image to the top view real-time image, i.e., the mapping relationship between the top view standard image and the top view real-time image, is calculated by an adaptive method. The mapping T may be obtained according to the pixel coordinates of a plurality of actual reference points of the game tabletop in the top view standard image and the pixel coordinate of the corresponding reference point in the top view real-time image.

In the third step, the positions P1′ and P2′ of P1 and P2 mapped to the top view real-time image are calculated.

In the fourth step, the straight line L composed of P1′ and P2′: y=Ax+B, is calculated, where x is the abscissa and y is the ordinate.

In the fifth step, any object position P0 (x0, y0) on the game tabletop is substituted to y=Ax+B to obtain the intersection position of the horizontal line and the straight line at P0 as (x′, y0).

In the sixth step, if x′>x0, it means that P0 is on the right side of the straight line L, and the recognition result on the right view image is selected to be merged into the recognition result of the top view real-time image to determine the target recognition result. If x′<=x0, it means that P0 is on the left side of the straight line L, and the recognition result on the left view is selected to be merged into the recognition result of the top view real-time image to determine the target recognition result.

By the above steps, at least two reference points are selected in the game tabletop, and according to the mapping relationship between the top view standard image and the top view real-time image, the at least two reference points are mapped to the top view image to obtain at least two corresponding image reference points; and furthermore, a straight line, and the straight line expression corresponding to the straight line are determined according to at least two image reference points to determine whether any object on the game tabletop is on the left or right side of the straight line to select the recognition result corresponding to which side view image that needs to be referred to for merging into the recognition result of the top view real-time image. In this way, the side view image matching the real-time image is determined by determining the pixel coordinate and the linear function of the preset standard image, and then the target recognition result is determined according to the respective object recognition results of the side view image and the real-time image. In such a way, the probability of an error in selecting the side view image due to the angular deviation during real-time image collection may be reduced, thereby improving the accuracy of object recognition.

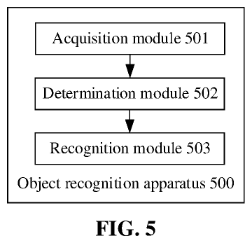

The embodiments of the present disclosure provide an object recognition apparatus. FIG. 5 illustrates a composition schematic diagram of an object recognition device according to an embodiment of the present disclosure. As illustrated in FIG. 5, the object recognition apparatus 500 may include an acquisition module 501, a determination module 502, and a recognition module 503.

The acquisition module 501 is configured to acquire a real-time image where a screen includes an object operation region.

The determination module 502 is configured to determine, according to the mapping relationship between the real-time image and a preset standard image, image reference points that match with at least two reference origins in the real-time. The reference origin is a point within the object operation region in the preset standard image.

The recognition module 503 is configured to recognize an object within the object operation region according to a pixel coordinate of the preset standard image and a reference pixel coordinate of the image reference point in the real-time image to obtain a target recognition result of the object.

In some embodiments, the acquisition module 501 is further configured to: acquire an image collection apparatus that has a preset inclination angle with the object operation region; and collect the object operation region by adopting the image collection apparatus to obtain the real-time image.

In some embodiments, the apparatus further includes a mapping determination module that is configured to: determine a transformation matrix between a pixel coordinate of the real-time image and a pixel coordinate of the preset standard image; and determine the mapping relationship according to the transformation matrix.

In some embodiments, the apparatus further includes a standard image acquisition module that is configured to: determine a first collection angle of the real-time image; and collect the object operation region by adopting a second collection angle to obtain the preset standard image, the difference between the second collection angle and the first collection angle is less than a preset angle threshold.

In some embodiments, the mapping determination module includes a pixel coordinate sub-module and a matrix determination sub-module. The pixel coordinate sub-module is configured to determine a preset reference point and a first pixel coordinate of the preset reference point in the preset standard image; and determine a second pixel coordinate of an image mapping point that matches the preset reference point in the real-time image; and the matrix determination sub-module is configured to determine the transformation matrix between the first pixel coordinate and the second pixel coordinate.

In some embodiments, the determination module 502 is further configured to project each of the reference origins into the real-time image according to the mapping relationship to obtain the image reference point matching each of the reference origins.

In some embodiments, the recognition module 503 includes a function determination sub-module and a recognition sub-module. The function determination sub-module may be configured to determine a linear function matching at least two of the image reference points according to the reference pixel coordinates of the at least two of the image reference points in the real-time image; and the recognition sub-module may be configured to recognize an object within an object operation region of the real-time image according to the linear function, a pixel coordinate of the preset standard image, and the real-time image to obtain the target recognition result.

In some embodiments, the recognition sub-module includes an input sub-unit, a comparison sub-unit, a recognition sub-unit, and a determination sub-unit. The input sub-unit may be configured to input a pixel coordinate of the preset standard image into the linear function to obtain a to-be-compared coordinate; the comparison sub-unit may be configured to numerically compare the pixel coordinate of the preset standard image with the to-be-compared coordinate to obtain a comparison result; the recognition sub-unit may be configured to recognize an object within the object operation region in the real-time image to obtain a to-be-adjusted recognition result; and the determination sub-unit may be configured to determine a target recognition result of the object according to the comparison result and to-be-adjusted recognition result.

In some embodiments, in the case where the preset standard image is a top view standard image, the determination sub-unit is further configured to: acquire a right side view image where a screen includes the object operation region, in the case where the comparison result represents that the pixel coordinate of the preset standard image is less than or equal to the to-be-compared coordinate; recognize the object within the object operation region in the right side view image to obtain a first recognition result; and adjust the to-be-adjusted recognition result according to the first recognition result to obtain the target recognition result.

In some embodiments, in the case where the preset standard image is a top view standard image, the determination sub-unit is further configured to: acquire a left side view image where a screen includes the object operation region, in the case where the comparison result represents that the pixel coordinate of the preset standard image is greater than or equal to the to-be-compared coordinate; recognize the object within the object operation region in the left side view image to obtain a second recognition result; and adjust the to-be-adjusted recognition result according to the second recognition result to obtain the target recognition result.

It should be noted that the descriptions of the above apparatus embodiments are similar to the descriptions of the above method embodiments, and have similar beneficial effects as the method embodiment. For technical details not disclosed in the device embodiments of the present disclosure, please refer to the description of the method embodiments of the present disclosure for understanding.

It should be noted that, in the embodiments of the present disclosure, if the above object recognition method is implemented in the form of a software function module and sold or used as an independent product, it may also be stored in a computer readable storage medium. According to this understanding, the technical solutions in the embodiments of the present disclosure may be embodied in the form of a software product in essence or a part that contributes to the prior art. The computer software product is stored in a storage medium and includes several instructions such that a computer device (which may be a terminal, a server, etc.) executes all or part of the method described in each of the embodiments of the present disclosure. The above storage media include: an U disk, a sports hard disk, a read only memory (ROM), a magnetic disk or an optical disk and other media that can store program codes. In such a way, the embodiments of the present disclosure are not limited to any specific combination of hardware and software.

Correspondingly, the embodiments of the present disclosure further provide a computer program product. The computer program product includes computer-executable instructions. After the computer-executable instructions are executed, the object recognition method according to the embodiments of the present disclosure may be implemented.

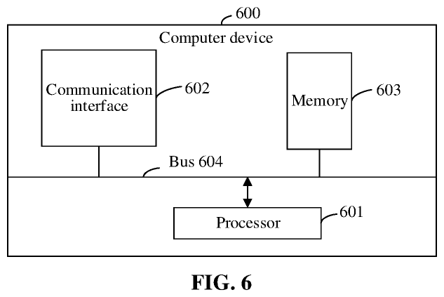

Correspondingly, the embodiments of the present disclosure provide a computer device. FIG. 6 illustrate a schematic composition diagram of a computer device according to an embodiment of the present disclosure. As illustrated in FIG. 6, the computer device 600 includes: a processor 601, at least one communication bus 604, a communication interface 602, at least one external communication interface and a memory 603. The communication interface 602 is configured to implement connection and communication between these components. The communication interface 602 may include a display screen, and the external communication interface may include a standard wired interface and a wireless interface. The processor 601 is configured to execute an image processing program in the memory to implement the object recognition method according to the above embodiments.

Correspondingly, the embodiments of the present disclosure further provide a computer storage medium having computer-executable instructions stored thereon, and when the computer-executable instructions are executed by a processor, the object recognition method according to the above embodiments is implemented.

The above descriptions of the object recognition apparatus, computer device, and storage medium embodiment are similar to the descriptions of the above method embodiments, and have similar technical descriptions and beneficial effects as the corresponding method embodiments. Due to space limitations, the descriptions of the above method embodiments may be followed, which will not be repeated herein. For technical details not disclosed in the embodiments of the object recognition apparatus, computer device, and storage medium of the present disclosure, please refer to the descriptions in the method embodiments of the present disclosure for understanding.

Embodiments of the disclosure further provide a computer program product, comprising computer readable codes, wherein when the computer readable codes run in a device, a processor in the device executes instructions for implementing the steps in the foregoing method.

It should be understood that the “one embodiment” or “an embodiment” mentioned throughout the specification means that a specific feature, structure, or characteristic related to the embodiments is included in at least one embodiment in the embodiments of the present disclosure. Therefore, the appearances of “in one embodiment” or “in an embodiment” in various places throughout the specification do not necessarily refer to the same embodiment. In addition, these specific features, structures, or characteristics may be combined in one or more embodiments in any suitable manner. It should be understood that, in the various embodiments in the embodiments of the present disclosure, the size of the sequence numbers of the above processes does not mean the order of execution. The execution order of various processes should be determined by their functions and internal logic, and should not constitute any limitation to the implementation process in the embodiments of the present disclosure. The sequence numbers in the above embodiments of the present disclosure are only for description, and do not represent the superiority or inferiority of the embodiments. It should be noted that in this article, the terms “include”, “contain or any other variants thereof are intended to cover non-exclusive inclusion, so that a process, method, article or apparatus including a series of elements not only includes those elements, but also includes other elements that are not explicitly listed, or elements inherent to the process, method, article, or apparatus. In the case where there are no more restrictions, the element defined by the sentence “including a . . . ” does not exclude the existence of other same elements in the process, method, article, or apparatus that includes the element.

In the several embodiments according to the embodiments of the present disclosure, it should be understood that the disclosed device and method may be implemented in other ways. The device embodiments described above are merely illustrative. For example, the division of the units is only a logical function division, and there may be other divisions in actual implementation, such as: a plurality of units or components may be combined, or they may be integrated into another system, or some features may be ignored or not implemented. In addition, the coupling, or direct coupling, or communication connection between the components shown or discussed may be indirect coupling or communication connection through some interfaces, devices or units, and may be in electrical, mechanical or other forms.

The units described above as separate components may or may not be physically separate, and the components displayed as units may or may not be physical units; they may be located in one place or distributed on a plurality network units; some or all of the units may be selected according to actual needs to achieve the object of the solution of this embodiment.

In addition, the functional units in the various embodiments in the embodiments of the present disclosure may all be integrated into one processing unit, or each unit may be individually taken as a unit, or two or more units may be integrated into one unit; the above integrated unit may be implemented in the form of hardware, or may be implemented in the form of hardware plus software functional units. A person of ordinary skill in the art may understand that all or part of the steps in the above method embodiments may be implemented by a program instructing relevant hardware. The above program may be stored in a computer readable storage medium. When the program is executed, the steps including the above method embodiments are performed; and the above storage medium includes: various media that may store program codes, such as a mobile storage device, a Read Only Memory (ROM), a magnetic disk, or an optical disk.

Alternatively, if the above integrated units in the embodiments of the present disclosure are implemented in the form of a software function module and sold or used as an independent product, they may also be stored in a computer readable storage medium. According to this understanding, the technical solutions in the embodiments of the present disclosure may be embodied in the form of a software product in essence or a part that contributes to the prior art. The computer software product is stored in a storage medium and includes several instructions such that a computer device (which may be a personal computer, a server, or a network device, etc.) executes all or part of the methods described in the various embodiments in the embodiments of the present disclosure. The above storage media includes: a mobile storage devices, a ROM, a magnetic disk or an optical disk and other media that may store program codes. The above are only specific implementations in the embodiments of the present disclosure, but the protection scope in the embodiments of the present disclosure is not limited to this. Any person familiar with the technical field may easily conceive of changes or replacements within the technical scope disclosed in the embodiments of the present disclosure, and they should be covered within the protection scope in the embodiments of the present disclosure. Therefore, the protection scope in the embodiments of the present disclosure should be subject to the protection scope of the claims.

1. An object recognition method, comprising:
acquiring a real-time image where a screen comprises an object operation region;
determining, according to a mapping relationship between the real-time image and a preset standard image, image reference points that match with at least two reference origins in the real-time, wherein the reference origin is a point within the object operation region in the preset standard image; and
recognizing an object within the object operation region according to a pixel coordinate of the preset standard image and a reference pixel coordinate of the image reference point in the real-time image to obtain a target recognition result of the object.

2. The method according to claim 1, wherein the acquiring a real-time image where a screen comprises an object operation region comprises:
acquiring an image collection apparatus that has a preset inclination angle with the object operation region; and
collecting the object operation region by adopting the image collection apparatus to obtain the real-time image.

3. The method according to claim 1, wherein before determining, according to the mapping relationship between the real-time image and a preset standard image, image reference points that match with at least two reference origins in the real-time image, the method further comprises:
determining a transformation matrix between a pixel coordinate of the real-time image and a pixel coordinate of the preset standard image; and
determining the mapping relationship according to the transformation matrix.

4. The method according to claim 1, wherein the method further comprises:
determining a first collection angle of the real-time image; and
collecting the object operation region by adopting a second collection angle to obtain the preset standard image, wherein a difference between the second collection angle and the first collection angle is less than a preset angle threshold.

5. The method according to claim 3, wherein the determining a transformation matrix between a pixel coordinate of the real-time image and a pixel coordinate of the preset standard image comprises:
determining, in the preset standard image, a preset reference point and a first pixel coordinate of the preset reference point;
determining, in the real-time image, a second pixel coordinate of an image mapping point that matches the preset reference point; and
determining a transformation matrix between the first pixel coordinate and the second pixel coordinate.

6. The method according to claim 3, wherein the determining, according to the mapping relationship between the real-time image and a preset standard image, image reference points that match with at least two reference origins in the real-time image comprises:
projecting each of the reference origins into the real-time image according to the mapping relationship to obtain the image reference point matching each of the reference origins.

7. The method according to claim 1, wherein the recognizing an object within the object operation region according to a pixel coordinate of the preset standard image and a reference pixel coordinate of the image reference point in the real-time image to obtain a target recognition result of the object, comprises:
determining a linear function matching at least two of the image reference points according to the reference pixel coordinates of the at least two of the image reference points in the real-time image; and
recognizing an object within an object operation region of the real-time image according to the linear function, a pixel coordinate of the preset standard image, and the real-time image to obtain the target recognition result.

8. The method according to claim 7, wherein the recognizing an object within an object operation region of the real-time image according to the linear function, a pixel coordinate of the preset standard image, and the real-time image to obtain the target recognition result, comprises:
inputting a pixel coordinate of the preset standard image into the linear function to obtain a to-be-compared coordinate;
numerically comparing the pixel coordinate of the preset standard image with the to-be-compared coordinate to obtain a comparison result;
recognizing an object within the object operation region in the real-time image to obtain a to-be-adjusted recognition result; and
determining a target recognition result of the object according to the comparison result and to-be-adjusted recognition result.

9. The method according to claim 8, wherein in a case where the preset standard image is a top view standard image, the determining a target recognition result of the object according to the comparison result and to-be-adjusted recognition result comprises:
in a case where the comparison result represents that the pixel coordinate of the preset standard image is less than or equal to the to-be-compared coordinate, acquiring a right side view image where a screen comprises the object operation region;
recognizing the object within the object operation region in the right side view image to obtain a first recognition result; and
adjusting the to-be-adjusted recognition result according to the first recognition result to obtain the target recognition result.

10. The method according to claim 8, wherein in a case where the preset standard image is a top view standard image, the determining a target recognition result of the object according to the comparison result and to-be-adjusted recognition result comprises:
in a case where the comparison result represents that the pixel coordinate of the preset standard image is greater than or equal to the to-be-compared coordinate, acquiring a left side view image where a screen comprises the object operation region;
recognizing the object within the object operation region in the left side view image to obtain a second recognition result; and
adjusting the to-be-adjusted recognition result according to the second recognition result to obtain the target recognition result.

11. A computer device, wherein the computer device comprises a memory storing computer-executable instructions thereon and a processor, when the processor runs the computer-executable instructions stored on the memory, the processor is caused to perform following operations:
acquiring a real-time image where a screen comprises an object operation region;
determining, according to a mapping relationship between the real-time image and a preset standard image, image reference points that match with at least two reference origins in the real-time image, wherein the reference origin is a point within the object operation region in the preset standard image; and
recognizing an object within the object operation region according to a pixel coordinate of the preset standard image and a reference pixel coordinate of the image reference point in the real-time image to obtain a target recognition result of the object.

12. The computer device according to claim 11, wherein the acquiring a real-time image where a screen comprises an object operation region comprises:
acquiring an image collection apparatus that has a preset inclination angle with the object operation region; and
collecting the object operation region by adopting the image collection apparatus to obtain the real-time image.

13. The computer device according to claim 11, wherein before determining, according to the mapping relationship between the real-time image and a preset standard image, image reference points that match with at least two reference origins in the real-time image, the operations further comprises:
determining a transformation matrix between a pixel coordinate of the real-time image and a pixel coordinate of the preset standard image; and
determining the mapping relationship according to the transformation matrix.

14. The computer device according to claim 11, wherein the operations further comprises:
determining a first collection angle of the real-time image; and
collecting the object operation region by adopting a second collection angle to obtain the preset standard image, wherein a difference between the second collection angle and the first collection angle is less than a preset angle threshold.

15. The computer device according to claim 13, wherein determining a transformation matrix between a pixel coordinate of the real-time image and a pixel coordinate of the preset standard image comprises:
determining a preset reference point and a first pixel coordinate of the preset reference point in the preset standard image;
determining a second pixel coordinate of an image mapping point that matches the preset reference point in the real-time image; and
determining the transformation matrix between the first pixel coordinate and the second pixel coordinate.

16. The computer device according to claim 13, wherein the determining, according to the mapping relationship between the real-time image and a preset standard image, image reference points that match with at least two reference origins in the real-time image comprises:
projecting each of the reference origins into the real-time image according to the mapping relationship to obtain the image reference point matching each of the reference origins

17. The computer device according to claim 11, wherein recognizing an object within the object operation region according to a pixel coordinate of the preset standard image and a reference pixel coordinate of the image reference point in the real-time image to obtain a target recognition result of the object, comprises:
determining a linear function matching at least two of the image reference points according to the reference pixel coordinates of the at least two of the image reference points in the real-time image; and
recognizing an object within an object operation region of the real-time image according to the linear function, a pixel coordinate of the preset standard image, and the real-time image to obtain the target recognition result.

18. The computer device according to claim 17, wherein the recognizing an object within an object operation region of the real-time image according to the linear function, a pixel coordinate of the preset standard image, and the real-time image to obtain the target recognition result, comprises
inputting a pixel coordinate of the preset standard image into the linear function to obtain a to-be-compared coordinate;
numerically comparing the pixel coordinate of the preset standard image with the to-be-compared coordinate to obtain a comparison result;
recognizing an object within the object operation region in the real-time image to obtain a to-be-adjusted recognition result; and
determining a target recognition result of the object according to the comparison result and to-be-adjusted recognition result.

19. The computer device according to claim 18, wherein in a case where the preset standard image is a top view standard image, the determining a target recognition result of the object according to the comparison result and to-be-adjusted recognition result comprises:
in a case where the comparison result represents that the pixel coordinate of the preset standard image is less than or equal to the to-be-compared coordinate, acquiring a right side view image where a screen includes the object operation region;
recognizing the object within the object operation region in the right side view image to obtain a first recognition result; and
adjusting the to-be-adjusted recognition result according to the first recognition result to obtain the target recognition result.

20. A non-transitory computer storage medium, wherein computer-executable instructions are stored on the non-transitory computer storage medium, and after the computer-executable instructions are executed, the following operations are implemented:
acquiring a real-time image where a screen comprises an object operation region;
determining, according to a mapping relationship between the real-time image and a preset standard image, image reference points that match with at least two reference origins in the real-time, wherein the reference origin is a point within the object operation region in the preset standard image; and
recognizing an object within the object operation region according to a pixel coordinate of the preset standard image and a reference pixel coordinate of the image reference point in the real-time image to obtain a target recognition result of the object.
